(19) United States
(12) Patent Application Publication
(10) Pub. No.: US 2024/0181375 A1
(43) Pub. Date: Jun. 6, 2024

(54) FILTER ASSEMBLY FOR EARTH RETAINING STRUCTURES

(71) Applicant: Jet Filter Systems, LLC, Casey, IL (US)

(72) Inventors: David HEILMAN, Fenville, MI (US); Doug STOUTIN, Casey, IL (US); David GENTRY, Casey, IL (US)

(21) Appl. No.: 18/530,743

(22) Filed: Dec. 6, 2023

Related U.S. Application Data
(60) Provisional application No. 63/430,525, filed on Dec. 6, 2022.

(51) Int. Cl. B01D 35/153; B01D 29/03; B01D 29/23

(52) U.S. Cl. CPC B01D 35/153; B01D 29/03; B01D 29/23; B01D 2201/347

(57) ABSTRACT

A filter assembly includes a grate portion having a plurality of drain passages therein. A check valve portion includes a first end connected to the grate portion and a filter portion is connected to a second end of the check valve portion. The grate portion, the check valve portion and the filter portion are disposed in a hole in a concrete structure.

### CROSS-REFERENCE TO RELATED APPLICATIONS

This application claims the benefit and priority of U.S. Provisional Application No. 63/430,525, filed on Dec. 6, 2022. The entire disclosure of the above application is incorporated herein by reference.

### FIELD

The present disclosure relates to a filter assembly for earth retaining structures.

### BACKGROUND

This section provides background information related to the present disclosure which is not necessarily prior art.

Earth structures require proper drainage. Inevitably, hydrostatic water pressure will build up behind the earth retaining structure. Without proper drainage, the earth retaining structure will fail over time. For example, water under a concrete slab below grade is subject to uplift pressure. This pressure needs to be relieved while soil fines do not pass when the water flows out. Some areas such as dam spillways, basins, culverts, aprons will also have times when there will be head pressure in front of the valve but must not be allowed to pass back into the system. In some instances, the head pressure can be fairly high. Conventional filter assemblies need to be improved to accommodate such applications.

### SUMMARY

This section provides a general summary of the disclosure, and is not a comprehensive disclosure of its full scope or all of its features.

According to an aspect of the present disclosure, a filter assembly includes a grate portion having a plurality of drain passages therein. A check valve portion includes a first end connected to the grate portion and a filter portion is connected to a second end of the check valve portion.

According to a further aspect, the grate portion includes a top plate having a plurality of mounting holes around a perimeter of the top plate and the plurality of drainage holes in a center of the top plate and the grate portion includes a bottom plate including a center hole that opens to the check valve portion.

According to a further aspect, a layer of filter fabric is sandwiched between the top plate and the bottom plate.

According to a further aspect, the bottom plate includes a plurality of inner mounting holes for mounting the bottom plate to the check valve portion.

According to a further aspect, the bottom plate includes a plurality of outer mounting holes that align with the mounting holes of the top plate.

According to a further aspect, the filter portion includes a filter housing with an upper flange having a plurality of mounting apertures for mounting the filter housing to a lower flange of the check valve portion.

According to a further aspect, the filter housing includes a conical shaped mesh body extending from the upper flange.

According to a further aspect, a gasket is disposed between the upper flange of the filter housing and the lower flange of the check valve portion.

According to a further aspect, the gasket includes a hole therethrough and a plurality of mounting holes.

According to a further aspect, a filter cartridge is received in the filter housing and includes an upper flange that fits within the hole of the gasket.

According to a further aspect, the filter cartridge includes a conical shaped mesh filter body reinforced by a frame structure.

According to a further aspect, the check valve portion includes a cylindrical housing with an upper flange with a plurality of mounting holes for mounting to a plurality of inner mounting holes of the bottom plate.

According to a further aspect, the check valve portion includes a lower flange with a plurality of mounting holes for mounting to the filter portion.

According to a further aspect, the check valve portion includes a valve member that sits against a valve seat to prevent backflow through the check valve portion.

According to a further aspect, the grate portion includes a top plate having a plurality of mounting holes around a perimeter of the top plate and the plurality of drainage holes in a center of the top plate and the grate portion includes a bottom plate including a center hole that opens to the check valve portion.

According to a further aspect, the grate portion, the check valve portion and the filter portion are disposed in a hole in a concrete structure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a filter assembly installed in a concrete structure according to the principles of the present disclosure;

FIG. 2 is a top plan view of the filter assembly;

FIG. 3 is a cross-sectional of the filter assembly according to the principles of the present disclosure; and

FIG. 4 is an exploded perspective view of the filter assembly according to the principles of the present disclosure.

Corresponding reference numerals indicate corresponding parts throughout the several views of the drawings.

### DETAILED DESCRIPTION

Example embodiments will now be described more fully with reference to the accompanying drawings.

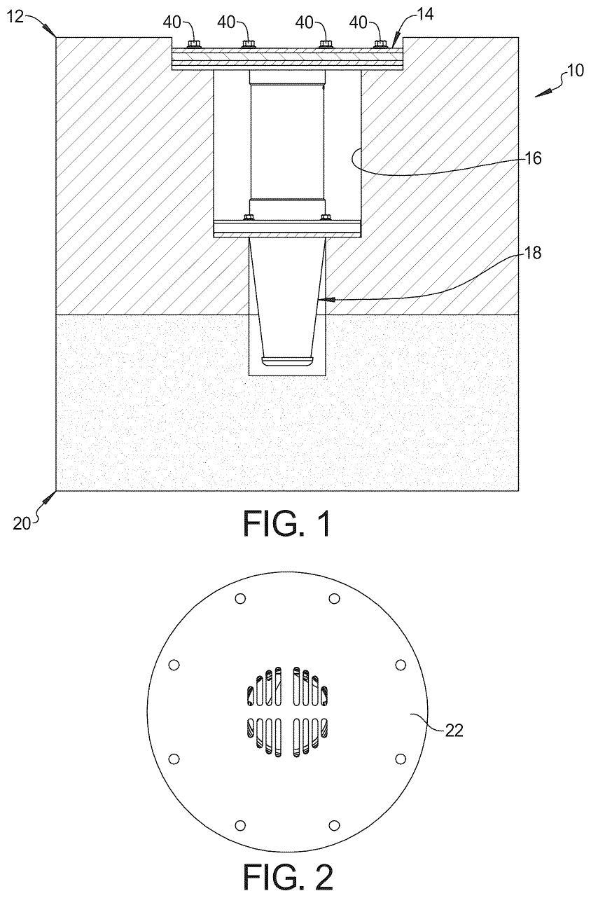

With reference to FIG. 1, a filter assembly 10 is shown installed in a concrete structure 12. The filter assembly 10 includes a grate portion 14, a check valve portion 16 and a filter portion 18. The grate portion 14 can be recessed from a surface 12a of the concrete structure 12 or other earth retaining structure. The earth retaining structure can include bricks, blocks, stones, poured concrete, asphalt, steel, other retaining wall materials, and walkway, driveway and roadway surfaces. The filter portion 18 extends from the earth retaining structure into a backfill material 20 such as gravel, sand or soil.

With reference to FIG. 1, the filter assembly 10 is designed to be installed horizontally in a wall structure or vertically into a floor of a structure. The filter assembly 10 allows water that is accumulated under a floor or behind a wall to be released through the filter assembly while preventing water from passing backward through the check valve portion 16 of the filter assembly 10.

With reference to FIG. 4, the grate portion 14 includes a top plate 22 having a plurality of mounting holes 24 around a perimeter of the top plate 22 and a plurality of drainage holes 26 in a center of the top plate 22. An optional layer of geotextile filter fabric 28 provides an initial filter layer to prevent sand and other sediment from entering the check valve portion 16. Other types of filter fabric can be used. A bottom plate 30 includes a center hole 32 that opens to the check valve portion 16. The center hole 32 is preferably large enough to fit a hand into so that any muck that collects on the valve can be removed. It can also be power washed or hosed out by removing the top plate 22 and the fabric 28. The fabric 28 can also be cleaned or replaced. The bottom plate 30 includes a plurality of inner mounting holes 34 for mounting the bottom plate to the check valve portion 16 with fasteners 36. The bottom plate 30 further includes a plurality of outer mounting holes 38 that align with the mounting holes 24 of the top plate 22 for mounting the top plate 22 to the bottom plate 30 with fasteners 40. The fasteners 40 can be threaded bolts that are countersunk into the concrete 12. The bottom plate 30 can slide down over the fasteners 40, then the fabric 28 can be installed with holes in the fabric 28 corresponding to the location of the bolts 40. The top plate 22 can then be slid over the bolts 40 to sandwich and hold the fabric 28 in place. Nuts can then be used to secure the grate portion 14 in place. Other types of fastener systems can be used. An annular gasket 42 includes a plurality of mounting holes 44 that align with the mounting holes 24 of the top plate 22 and the mounting holes 38 of the bottom plate 30. The annular gasket 42 is designed to seal on smooth or rough surfaces. The gasket 42 prevents water from passing around the filter assembly 10.

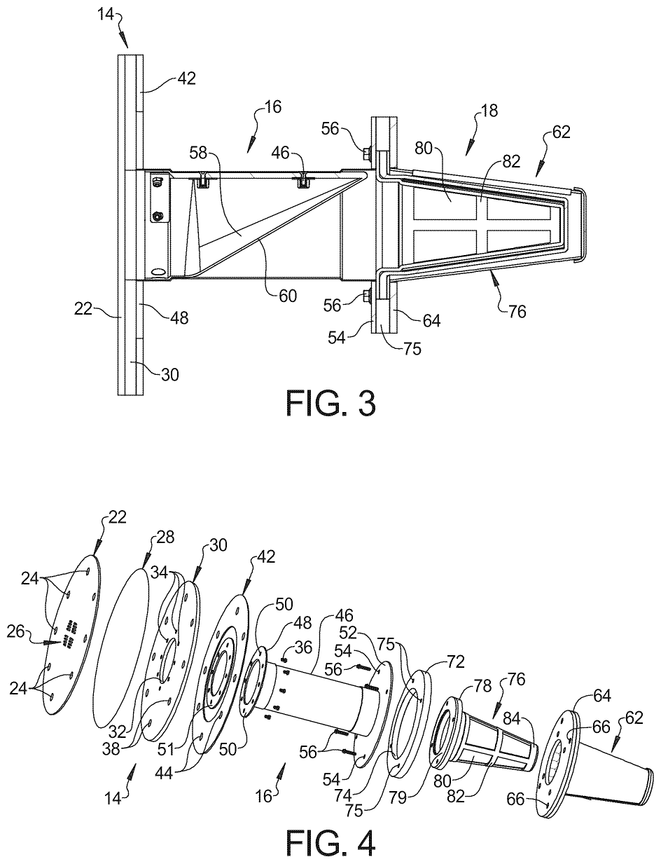

The check valve portion 16 includes a cylindrical housing 46 with an upper flange 48 with a plurality of mounting holes 50 for mounting to the plurality of inner mounting holes 34 of the bottom plate 30 by the fasteners 36. An additional gasket 51 can be provided between the upper flange of the cylindrical housing 46 and the bottom plate 30. The check valve portion 16 further includes a lower flange 52 with a plurality of mounting holes 54 for mounting to the filter portion 18 by a plurality of fasteners 56. With reference to the cross-sectional view of FIG. 3, the check valve portion 16 includes a valve member 58 that seats against a valve seat 60 to prevent backflow through the check valve portion 16. The valve member 58 can be a diaphragm, a clapper or another type of valve member. Check valves of this type are generally known in the art.

The filter portion 18 includes a filter housing 62 with an upper flange 64 having a plurality of mounting apertures 66 for mounting the filter housing 62 to the lower flange 52 of the check valve portion 16 by the fasteners 56. The filter housing 62 includes conical shaped mesh body 68 extending from the upper flange 64 and an end mesh 70 at an end of the filter housing 62. A gasket 72 is disposed between the upper flange 64 of the filter housing 62 and the lower flange 52 of the check valve portion 16. The gasket 72 includes a hole 74 therethrough and a plurality of mounting holes 75. A filter cartridge 76 is received in the filter housing 62 and includes an upper flange 78 that fits within the hole 74 of the gasket 72. An additional gasket 79 can be provided between the upper flange 78 of the filter cartridge 76 and the lower flange 52 of the check valve portion. The filter cartridge 76 includes a conical shaped mesh filter body 80 reinforced by a frame structure 82 and an end mesh 84 at an end of the filter cartridge 76. The filter cartridge 76 and filter housing 62 can be an open end filter commercially available from Jet Filter Systems. Other types of filters also fall within the scope of the present disclosure.

The present disclosure provides an integrated grate portion 14 and an inline check valve portion 16. The grate portion 14 prevents large items from entering into the check valve portion 16. The grate portion can include a thick stainless steel top plate 22 that is strong enough to withstand heavy machinery driving over it. The top plate 22 is preferably counter sunk below the level of the concrete 12. For example, a basin may collect silt when full of water. The silt will fall to the bottom. When the basin is dry, they use heavy machinery to remove the silt in which case they may drive over the filter assembly.

The bolts 36 connecting the inline check valve 16 with the bottom plate 30. The bolts 36 are installed from the backside into the bottom plate 30 otherwise the bolts would interfere with the placement of the unit.

The bolts 56 bolts and gasket 72 allow the entire product to be installed in different scenarios. First, engineers may wish the entire unit 10 to lie or rest against a ledge cored deep in the hole. For example, they core an 8″ hole approximately 10″ deep. Then they core a 4″ hole an additional 8″. The 4″ core would be exactly in the center of the 8″ hole. This would create a ledge where the 8″ hole drops to a 4″ hole. The unit 10 is set into the hole with the back of the flange 66 resting on or up against the ledge.

In order to rest completely on the ledge, new bolts need to be added that would not penetrate fully through the lower flange 54, the gasket 72 and the upper flange 64 without sticking out the back of the upper flange 64.

The gasket 42 allows water or sediment to leak into the connect. At the same time, the gasket had to reduce any chance the cartridge 76 could push up away from the housing 62. Doing so would allow water and soils to pass around the filter cartridge 76.

In some installations, such as not using a ledge, flowing water would fill up the entire core and carry soil fines with it. The gaskets 42, 72 seal the system so the water is forced through the filter cartridge 76 and is not allowed to bypass the filter fabric 80.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A filter assembly, comprising:
a grate portion having a plurality of drain passages therein;
a check valve portion having a first end connected to the grate portion; and
a filter portion connected to a second end of the check valve portion.

2. The filter assembly according to claim 1, wherein the grate portion includes a top plate having a plurality of mounting holes around a perimeter of the top plate and the plurality of drainage holes in a center of the top plate and the grate portion includes a bottom plate including a center hole that opens to the check valve portion.

3. The filter assembly according to claim 2, further comprising a layer of filter fabric sandwiched between the top plate and the bottom plate.

4. The filter assembly according to claim 2, wherein the bottom plate includes a plurality of inner mounting holes for mounting the bottom plate to the check valve portion.

5. The filter assembly according to claim 4, wherein the bottom plate includes a plurality of outer mounting holes that align with the mounting holes of the top plate.

6. The filter assembly according to claim 1, wherein the filter portion includes a filter housing with an upper flange having a plurality of mounting apertures for mounting the filter housing to a lower flange of the check valve portion.

7. The filter assembly according to claim 6, wherein the filter housing includes a conical shaped mesh body extending from the upper flange.

8. The filter assembly according to claim 7, wherein a gasket is disposed between the upper flange of the filter housing and the lower flange of the check valve portion.

9. The filter assembly according to claim 8, wherein the gasket includes a hole therethrough and a plurality of mounting holes.

10. The filter assembly according to claim 8, wherein a filter cartridge is received in the filter housing and includes an upper flange that fits within the hole of the gasket.

11. The filter assembly according to claim 10, wherein the filter cartridge includes a conical shaped mesh filter body reinforced by a frame structure.

12. The filter assembly according to claim 2, wherein the check valve portion includes a cylindrical housing with an upper flange with a plurality of mounting holes for mounting to a plurality of inner mounting holes of the bottom plate.

13. The filter assembly according to claim 12, wherein the check valve portion includes a lower flange with a plurality of mounting holes for mounting to the filter portion.

14. The filter assembly according to claim 1, wherein the check valve portion includes a valve member that seats against a valve seat to prevent backflow through the check valve portion.

15. The filter assembly according to claim 14, wherein the grate portion includes a top plate having a plurality of mounting holes around a perimeter of the top plate and the plurality of drainage holes in a center of the top plate and the grate portion includes a bottom plate including a center hole that opens to the check valve portion.

16. The filter assembly according to claim 15, further comprising a layer of filter fabric sandwiched between the top plate and the bottom plate.

17. The filter assembly according to claim 14, wherein the filter portion includes a filter housing with an upper flange having a plurality of mounting apertures for mounting the filter housing to a lower flange of the check valve portion.

18. The filter assembly according to claim 15, wherein the check valve portion includes a cylindrical housing with an upper flange with a plurality of mounting holes for mounting to a plurality of inner mounting holes of the bottom plate.

19. The filter assembly according to claim 18, further comprising a layer of fabric sandwiched between the top plate and the bottom plate.

20. The filter assembly according to claim 1, wherein the grate portion, the check valve portion, and the filter portion are disposed in a hole in an earth retaining structure.
